(19) United States
(12) Patent Application Publication
(10) Pub. No.: US 2007/0070041 A1
(43) Pub. Date: Mar. 29, 2007

(54) Cursor control and input device with safety cut-off

(75) Inventors: Ming Tat Chan, Singapore (SG); Poo Dee Choo, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 11/234,430

(22) Filed: Sep. 23, 2005

(51) Int. Cl. G09G 5/08

(52) U.S. Cl. 345/166

(57) ABSTRACT

There is provided a cursor control and input device for connection to a computer. The cursor control and input device includes a housing assembly with at least one base; at least one hole of predetermined shape and size in the at least one base; an integrated circuit board mounted in the housing assembly; a lens mounted adjacent to the hole; and a beam emitter for illuminating an area at a predetermined distance from the base. The beams reflected from the illuminated area may be focussed by the lens onto the integrated circuit board and the beam emitter may be cut-off using a safety means when the device is lifted from a reference surface. The integrated circuit board may advantageously include at least one beam detecting sensor.

### TECHNICAL FIELD

This invention relates to an optical mouse with the capability to cut-off a beam emitter source so as to prevent accidental injury to a user's eyes from prolonged exposure to the light emitting source.

### BACKGROUND

Optical mice are becoming more prevalent as prices fall and consumers realize the benefits of not having to maintain the mechanical parts of track ball-based mice. Wider consumer acceptance has also come about because of the precise cursor control afforded by optical mice, with precision of 800 dpi becoming the norm. The precision that optical mice allow a user to control a cursor has led to such mice being the controller of choice for many games requiring quick and precise cursor movements. It is to be noted that a significant proportion of regular gamers are children under the age of twelve.

Even though manufacturers of the beam emitting sources used in optical mice have certified their light sources to be “eye-safe”, there are concerns that mishaps may occur due to human, electrical or mechanical faults that may cause the light sources to intensify and cause damage to an eye. This is especially so when optical mice utilize beams like lasers that are not visible to the naked eye and a user may not even realize that there is exposure to the laser. The loss of the user's sight resulting from such incidents will be very unfortunate and should be avoided.

### SUMMARY

There is provided a cursor control and input device for connection to a computer. The cursor control and input device may be connected via a wired connection or wirelessly using protocols such as Bluetooth, UWB, RF or IR.

The cursor control and input device includes a housing assembly with at least one base; at least one hole of predetermined shape and size in the at least one base; an integrated circuit board mounted in the housing assembly; a lens mounted adjacent to the hole; and a beam emitter for emitting a beam to illuminate an area a predetermined distance from the base. The beam reflected from the illuminated area may be focussed by the lens onto the integrated circuit board and the beam emitter may be cut-off using a safety cut-out when the device is lifted from a reference surface. The integrated circuit board may advantageously include at least one beam detecting sensor.

Preferably, the beam emitter is either a LED or a laser diode. It is also preferable that the predetermined distance is measured from a bottom surface of the base of the housing assembly to the reference surface. The safety cut-out may be selected from firmware with at least one sensor to ascertain that reflected beam is off focus, toggling of a switch, at least one barrier to block the beam emitted from the beam emitter, at least one barrier to block the beam emitted from the at least one hole of predetermined shape and size in the at least one base, using light blocking properties of the barrier or a combination of the aforementioned. The barrier may be solid, liquid or gel. The at least one solid barrier may preferably be biased.

### BRIEF DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

In the drawings:

FIG. 1 shows an exploded view of key components of a first embodiment;

FIG. 2 shows an exploded view of key components of a second embodiment;

FIG. 3 shows an exploded view of key components of a third embodiment;

FIG. 4 shows a flow chart of the embodiment of FIG. 3;

FIG. 5 shows the cross sectional view of another implementation of the second embodiment;

FIG. 6 shows an exploded view of key components of a fourth embodiment; and

FIG. 7 shows an exploded view of key components of a fifth embodiment.

### DETAILED DESCRIPTION OF PREFERRED EMBODIMENTS

The following discussion is intended to provide a brief, general description of a suitable computing environment in which the present invention may be implemented. As those skilled in the art will appreciate, the invention may be practiced with other computer system configurations, including hand-held devices, multiprocessor systems, microprocessor-based or programmable consumer electronics, minicomputers, and the like.

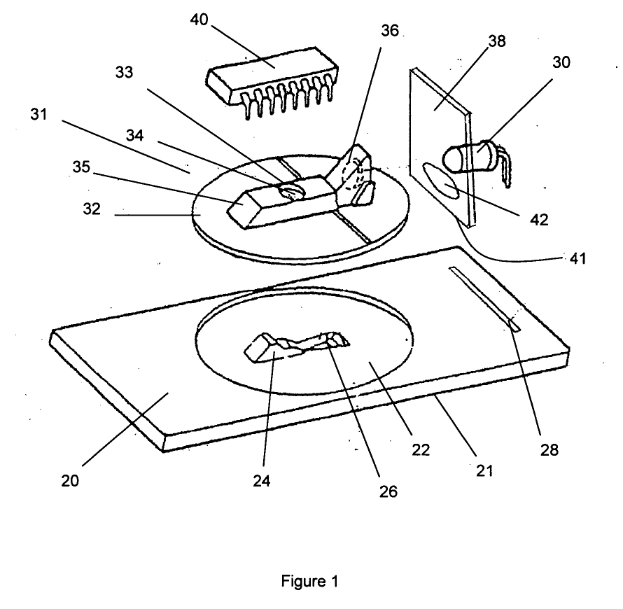

A first embodiment is shown in FIG. 1. There are shown key components of a cursor control and input device for connection to a computer. The cursor control and input device includes buttons to facilitate a point-and-click functionality. The cursor control and input device may also be known as a mouse and does not differ to existing mice in the way it is used. The connection to the computer may be wired or wireless. A wired connection would enable the device to be powered by the computer while a wireless device would need to be independently powered. The wireless device may employ wireless protocol such as, for example, Bluetooth, UWB, RF or IR.

The cursor control and input device may have a housing assembly to contain all the components when they are functionally integrated. The housing assembly may have at least one base 20. The base 20 may have at least one hole 26 of a predetermined shape, such as, for example, triangular, elliptical, quadrilateral, polygonal or any other desired shape. The size of hole 26 may preferably be large enough to allow the passage of beams through the base 20. There may be more than one hole 26, with one hole allowing the passage of beams from within the housing assembly and one hole allowing the passage of beams from outside the housing assembly. However, this embodiment is not shown in the Figures.

The base 20 may have a depression 22. In the present embodiment, the depression 22 and a shaped notch 24 in the base 20 are used to facilitate the fitting of an optical module 31 onto the base 20. A bottom 32 of the optical module 31 may fit into the depression 22. The shaped notch 24 may fit into a shaped guide 35 of the optical module 31 when the bottom 32 of the optical module 31 is fitted into the depression 22. In the present embodiment, the base 20 may also have a slot 28. The slot 28 and a barrier 38 with an opening 42 aid in ensuring the safety of a user of the cursor control and input device, as will be explained below. The opening 42 is shown to be elliptical, but may be of any shape such as, for example, triangular, quadrilateral, polygonal or any other desired shape.

The optical module 31 includes a mirror 36 to reflect light from a beam emitter 30. The beam emitter 30 may be a LED or a laser diode. The laser diode may transmit beams that are not visible to the naked eye as the beams are transmitted at a frequency beyond the visible spectrum of light. The mirror 36 directs the beams through the at least one hole 26 in the base 20, and the beams illuminate an area at a predetermined distance from the base 20. The beams will be reflected off the area at a predetermined distance from a bottom surface 21 of the base 20 and a reference surface and will pass through the at least one hole 26 in the base 20. The predetermined distance may be measured from the bottom surface 21 of the base 20 of the housing assembly to a reference surface and should not be too large as the beam emitter would need to transmit higher intensity beams if the beams were to be reflected over larger distances.

The optical module 31 also includes a lens 34 mounted in a gap 33 for focussing reflected beams onto an integrated circuit 40 that is mounted above the optical module 31 in the present embodiment. The integrated circuit 40 may include sensors to detect the reflected beams passing through the at least one hole 26 in the base 20 that are focussed by the lens 34. The lens 34 in the optical module 31 may be mounted adjacent to the at least one hole 26 in the base 20 to be able to focus the reflected beams.

In a normal operation of the present embodiment, the barrier 38 may be inserted into slot 28. When a user utilizes the cursor control and input device by placing a hand on the device, a force will be applied to the top of the cursor control and input device and this ensures that a bottom edge 41 of the barrier 38 is aligned with the bottom surface 21 of the base 20. In this arrangement, the beam emitter 30 is aligned with the opening 42 and beams from the beam emitter 30 are able to pass through the opening 42 and enable normal functionality of the cursor control and input device.

When the user stops using the cursor control and input device and removes his hand, the force applied to the top of the cursor control and input device is consequently removed. In the present embodiment, where the barrier 38 is biased to a blocking position—downwardly in this case—a removal of the force exerted by the user causes the barrier to slide downwardly through the slot 28 such that beams from the beam emitter are blocked by the barrier 38 as the beam emitter 30 is not aligned with the opening 42. This effectively cuts-off the beams that are transmitted through the at least one hole 26.

In an alternative arrangement, instead of having the barrier 38 move up-and-down in a vertical plane, the barrier 38 may be moved left-and-right in a horizontal plane, with an opening (off-centre or otherwise) being aligned to the beam emitter 30 thus allowing beams from the beam emitter 30 to be able to pass through the opening. In this alternative embodiment, the slot 28 may be a groove and act as a guide for the bottom edge 41 of the barrier 38. The opening may also be optional as sliding the barrier 38 to one side would block the beam emitter 30 and sliding to the other side would allow the passage of beams from the beam emitter 30. Such a barrier 38 would not need to be biased. However, it is to be noted that this alternative arrangement of the barrier does not automatically cut-off the beam emitter 30 and requires user intervention for cut-off.

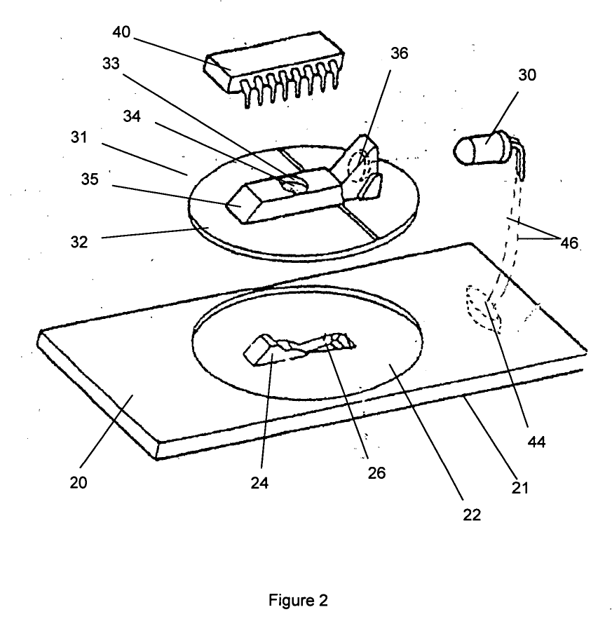

A second embodiment of the present invention is shown in FIG. 2. All components are identically numbered as in FIG. 1. The main difference in FIG. 2 is the use of a compressible switch 44 incorporated on the bottom surface 21 of the base 20. The switch 44 is connected to the beam emitter 30 using wires 46. In this embodiment, when the user utilizes the cursor control and input device by placing a hand on the device, a force will be applied to the top of the cursor control and input device and this ensures the switch 44 is compressed. When the switch 44 is compressed, a circuit between the switch 44 and the beam emitter 30 is closed, thus enabling the beam emitter 30 to be powered to enable normal operability of the cursor control and input device.

When the user stops utilizing the cursor control and input device, the hand is removed from the device, and consequently, the force is removed from the top of the cursor control and input device, ensuring that the switch 44 is not compressed. When the switch 44 is not compressed, the circuit between the switch 44 and the beam emitter 30 is open, thus disabling the beam emitter 30. This cuts off the transmission of all beams from the beam emitter 30.

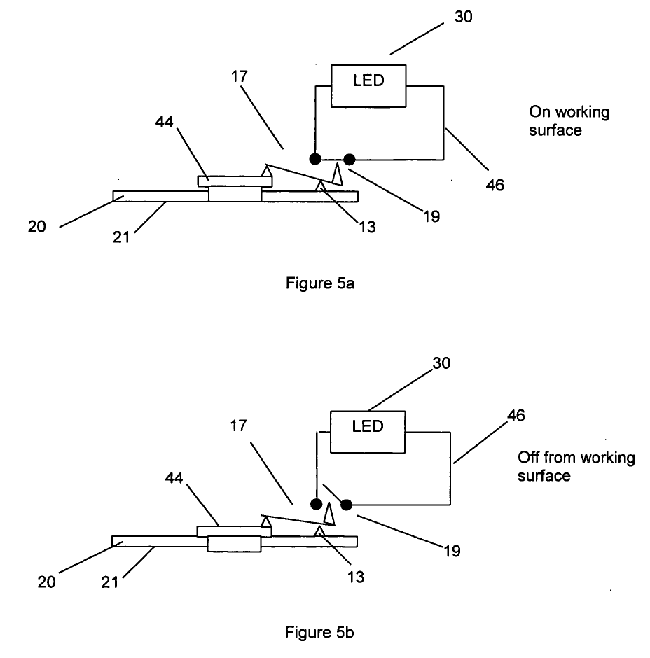

FIG. 5 shows an alternative implementation of the present embodiment. FIG. 5a shows the cursor control and input device when placed on a working surface in cross sectional view. The switch 44 is connected to a cantilever system 17 supported by pivot 13. When the cursor control and input device is placed on a working surface, the biased circuit switch 19 is closed and the beam emitter 30 is operational. However, when the cursor control and input device is lifted off a working surface (as shown in FIG. 5b), the switch 44 will drop due to gravity or due to the switch 44 being biased. This causes the cantilever system 17 to pivot about pivot 13 and open the biased circuit switch 19, and consequently switching off beam emitter 30. When the cursor control and input device is placed back on a working surface (FIG. 5a), the cantilever system 17 reverts to its original position and the biased circuit switch 19 automatically closes. Thus, this alternative implementation also cuts off the transmission of beams from the beam emitter 30. It is conceivable that the switch 44 may also be in the shape of a sphere.

In another embodiment of the present invention that is not shown in the Figures, the compression of the switch 44 may open a shutter covering the at least one hole 26 while non-compression closes the shutter covering the at least one hole 26. In this embodiment, the switch 44 need not be electrically connected to the beam emitter 30 and may instead be a mechanical switch that toggles the opening and closing of the shutter. This embodiment effectively cuts-off the beams that are transmitted through the at least one hole 26.

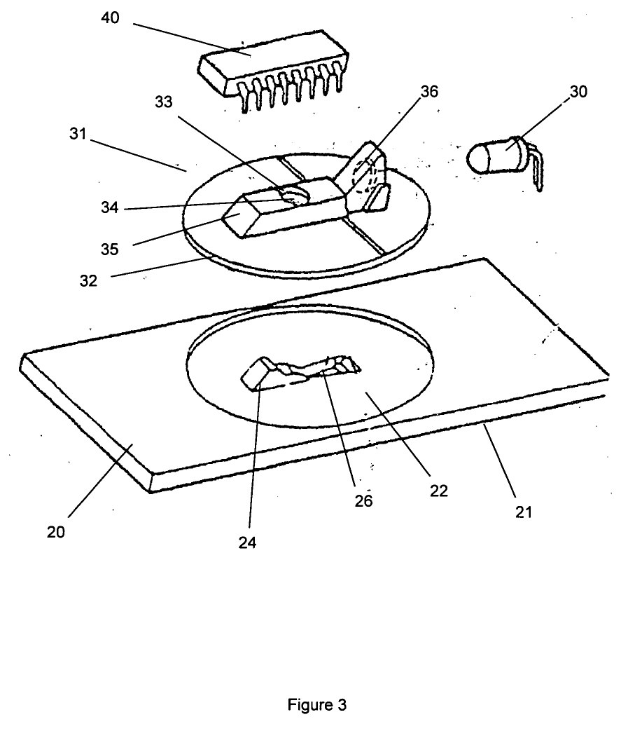

FIG. 3 shows the key components required in a third embodiment of the present invention. All components are numbered as per the embodiments as described earlier and the general operation of the cursor control and input device remain the same. However, this embodiment relates to a process that occurs in the firmware implemented onto the integrated circuit 40.

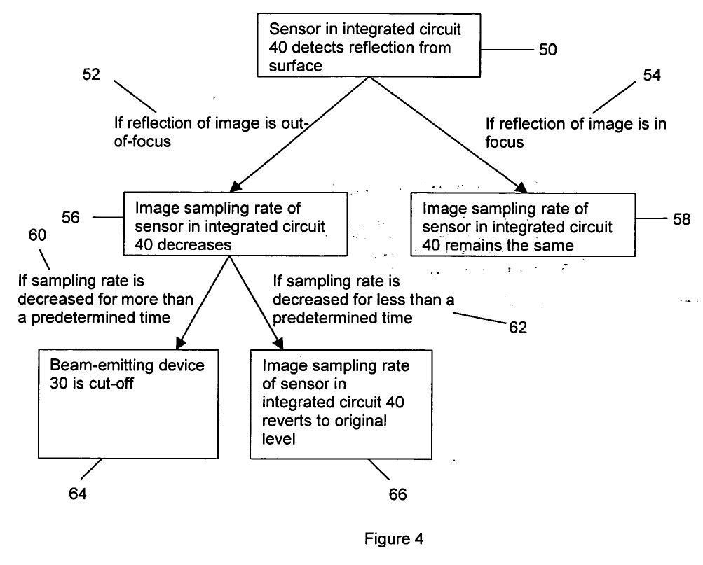

FIG. 4 shows a flow chart of the process that occurs in the firmware implemented onto the integrated circuit 40. A sensor in the integrated circuit 40 detects reflection of beams from the illuminated area passing through the at least one hole 26 and the lens 34 of the optical module 31 (50). A processor in the integrated circuit 40 determines if the reflected beams form an image that is out-of-focus (52) or in focus (54).

In the instance when the reflection of the beams form a focused image, the image sampling rate of the sensor in the integrated circuit 40 remains the same (58) as the cursor control and input device is in normal use at the predetermined distance from the bottom surface 21 of the base 20 to the reference surface.

In the instance when the reflection of the beams form an out-of-focus image, the image sampling rate of the sensor in the integrated circuit 40 decreases (from 3.3 KHz to 100 Hz) as the processor has determined that the cursor control and input device is further than the predetermined distance from the bottom surface 21 of the base 20 to the reference surface (56). If the sampling rate is decreased for less than a predetermined time (62), such as, for example, one second, the image sampling rate of the sensor in the integrated circuit 40 reverts to its original level (66). Similarly, if the sampling rate is decreased by more than the predetermined time (60), the beam emitter 30 is cut-off (64), thus effectively cutting off the beams that are transmitted through the at least one hole 26. When the beam emitter 30 is cut-off, the cursor control and input device enters sleep or stand-by mode, and the cursor control and input device will be awoken or re-activated with the pressing of the buttons on the cursor control and input device.

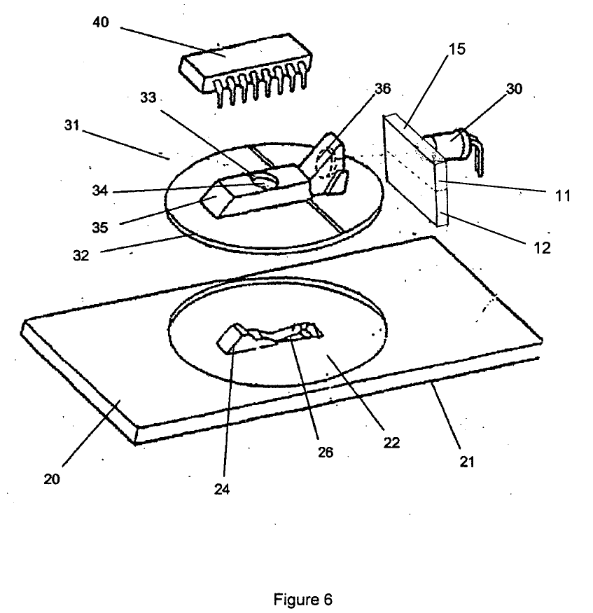

FIG. 6 shows the key components required in a fourth embodiment of the present invention. All components are numbered as per the embodiments as described earlier and the general operation of the cursor control and input device remain the same. In this embodiment, there is a transparent container 15 for containing at least two liquids 11, 12 of substantially different densities and light refractive indices. When the cursor control and input device is in use on a working surface, the less dense liquid 11 should float on the denser liquid 12. The less dense liquid 11 should have a refractive index close to the value of one that allows beams of the beam emitter 30 to pass through with minimal loss in intensity. However, when the cursor control and input device is lifted from the working surface and tilted from an original position where the base 20 is parallel to the working surface, liquid 11 and liquid 12 will be mixed prior to settling in different layers and it is at this time when the denser liquid 12 with a refractive index greater than one refracts and diffracts beams of the beam emitter 30. This reduces the intensity of the beams of the beam emitter 30 and may even block beams from exiting from the at least one hole 26. Subsequently, placing the cursor control and input device on a working surface will allow beams of the beam emitter 30 to be transmitted from the hole 26.

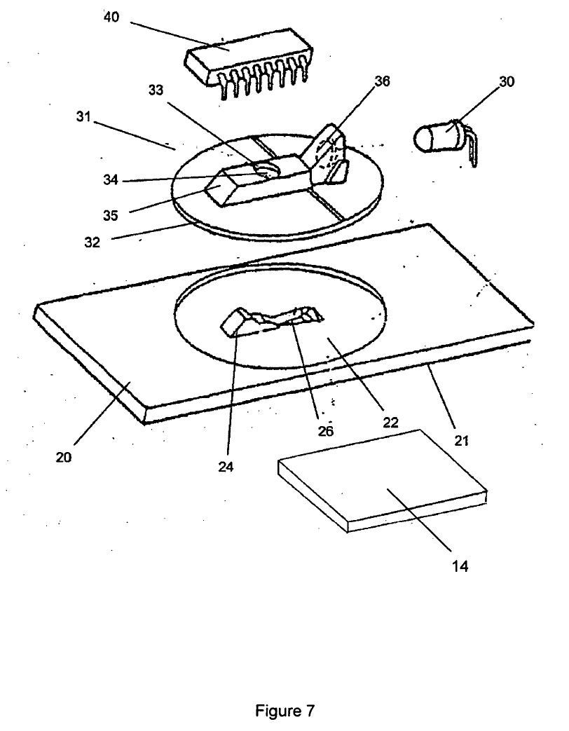

FIG. 7 shows the key components required in a fifth embodiment of the present invention. All components are numbered as per the embodiments as described earlier and the general operation of the cursor control and input device remain the same. In this embodiment, there is a removable compartment 14 that may be located in a receptor in the bottom surface 21 of the base 20. The removable compartment 14 may have surfaces that allow the passage of light to the contained material. The removable compartment 14 may not contact the working surface so as to minimize scratches on the surfaces of the removable compartment 14. The receptor for the removable compartment 14 may include the hole 26. The removable compartment 14 may preferably contain light-sensitive materials such as liquids or gels that improve the light blocking properties of the materials when exposed to light.

As such, when the cursor control and input device is lifted off a working surface, exposure of light of the material in the removable compartment 14 causes the material to block light from passing through the removable compartment 14, consequently also blocking beams of the beam emitter 30 from exiting from the at least one hole 26. Subsequently, placing the cursor control and input device on a working surface will allow beams of the beam emitter 30 to be transmitted from the hole 26 as the material in the removable compartment 14 allows the passage of beams of the beam emitter 30, which may not be within the visible spectrum.

All embodiments of the present invention described earlier may be employed independently or in combination. There are no restrictions with regard to the combinations of the present invention that may be employed in a cursor control and input device.

Whilst there has been described in the foregoing description preferred embodiments of the present invention, it will be understood by those skilled in the technology concerned that many variations or modifications in details of design or construction may be made without departing from the present invention.

1. A cursor control and input device for connection to a computer, including:
a housing assembly with at least one base;
at least one hole of predetermined shape and size in the at least one base;
an integrated circuit board mounted in the housing assembly;
a lens mounted adjacent to the hole; and
a beam emitter for emitting a beam to illuminate an area at a predetermined distance from the base,
wherein a beam reflected from the illuminated area is able to be focused by the lens onto the integrated circuit board
and wherein the beam emitter is cut-off using a safety cut-off when the device is lifted from a reference surface.

2. The cursor control and input device as claimed in claim 1, wherein the beam emitter is selected from the group comprising: a LED and a laser diode.

3. The cursor control and input device as claimed in claim 1, wherein the predetermined distance is measured from a bottom surface of the base of the housing assembly to the reference surface.

4. The cursor control and input device as claimed in claim 1, wherein the safety cut-off is selected from the group consisting of: firmware with at least one sensor to ascertain that reflected beam is off focus, toggling of a switch, at least one barrier to block the beam emitted from the beam emitter, at least one barrier to block the beam emitted from the at least one hole of predetermined shape and size in the at least one base, using light blocking properties of the barrier, and a combination of the aforementioned.

5. The cursor control and input device as claimed in claim 4, wherein the barrier is selected from the group of materials consisting of: solid, liquid and gel.

6. The cursor control and input device as claimed in claim 1, wherein the connection to the computer is wired.

7. The cursor control and input device as claimed in claim 1, wherein the connection to the computer is wireless.

8. The cursor control and input device as claimed in claim 7, wherein a wireless protocol used is selected from the group consisting of: Bluetooth, UWB, RF and IR.

9. The cursor control and input device as claimed in claim 1, wherein the integrated circuit board includes at least one beam detecting sensor.

10. The cursor control and input device as claimed in claim 5, wherein the solid barrier is biased to a cut-off position.
